(19) United States
(12) Patent Application Publication
(10) Pub. No.: US 2012/0201192 A1
(43) Pub. Date: Aug. 9, 2012

(54) METHOD AND APPARATUS FOR RELAYING UPLINK SIGNALS

(75) Inventors: Sungkwon Hong, Ansan-si (KR); Kibum Kwon, Ansan-si (KR); Kyoungmin Park, Goyang-si (KR)

(73) Assignee: PANTECH CO., LTD., Seoul (KR)

(21) Appl. No.: 13/500,683

(22) PCT Filed: Oct. 6, 2010
(86) PCT No.: PCT/KR2010/006835

§ 371 Date: Apr. 6, 2012

(30) Foreign Application Priority Data
Oct. 6, 2009 (KR) 10-2009-0094856

(51) Int. Cl. H04W 88/04

(52) U.S. Cl. 370/315

(57) ABSTRACT

The present invention relates to a method and apparatus for relaying uplink signals, and provides a method and apparatus for relaying uplink signals which involve integrating a plurality of information blocks for signals received from a plurality of terminals to generate an integrated information block, encoding the thus-generated integrated information block, and transmitting the encoded block to a base station.

### CROSS-REFERENCE TO RELATED APPLICATIONS

This application is the National Stage Entry of International Application PCT/KR2010/006835, filed on Oct. 6, 2010, and claims priority from and the benefit of Korean Patent Application No. 10-2009-0094856, filed on Oct. 6, 2009, which are both incorporated herein by reference for all purposes as if fully set forth herein.

### BACKGROUND

1. Field

The present invention relates to a wireless communication system, and more particularly to a method and an apparatus for relaying uplink signals from multiple user equipments to a base station in a wireless communication system.

2. Discussion of the Background

Recently, in a communication system, technologies in which the application of a relay such as a repeater between a User Equipment (UE) and a base station enables an increase in a cell capacity and improvement in performance for users in a cell boundary area, have been developed. Particularly, 3GPP LTE (3^{rd} Generation Partnership Project Long Term Evolution) also plans to introduce relays, and a standardization activity related to the introduction of relays to the 3GPP LTE is in active progress.

Technologies, the development of which is in progress in relation to these relays, include “a relay technology using a network code,” the development of which is in active progress by 3GPP corresponding to the LTE standards body. In such a relay technology using a network code, when there are two user equipments, information data to be transmitted by a first user equipment is represented by i11, i12, . . . , and i1N, and information data to be transmitted by a second user equipment is represented by i21, i22, . . . , and i2N. Bits obtained by encoding information data to be transmitted by the first user equipment are represented by C11, C12, . . . , and C1M, and bits obtained by encoding information data to be transmitted by the second user equipment are represented by C21, C22, . . . , and C2M. A structure for transmitting a signal is as follows. In order to actually transmit a signal, encoded bits are modulated. For convenience of description, a description of transmission of a signal focuses on the transmission of an encoded bit. A signal is transmitted in uplink on a per-three slots basis. During a first slot, the first user equipment transmits C11, C12, . . . , and C1M in the form of broadcast to a relay apparatus and a base station. During a second slot, the second user equipment transmits C21, C22, . . . , and C2M in the form of broadcast to the relay apparatus and the base station. On the assumption that M=M′, the relay apparatus decodes a signal received during the first time slot and a signal received during the second time slot, and generates the following signal:

Cᵣ₁, Cᵣ₂, . . . , C_{rM}=C₁₁⊕C₂₁, C₁₂⊕C₂₂, . . . , C_{1M}⊕C_{2M}.

During a third time slot, the relay apparatus transmits Cr1, Cr2, . . . , and CrM to the base station.

Generally, when a user equipment uses a TDM (Time Division Multiplexing) scheme to transmit a signal to a base station in a cooperative diversity scheme together with a relay apparatus, the user equipment requires two slots. When there are two user equipments, they require four slots. In contrast, when the two user equipments use a network code scheme, they require only three slots. Accordingly, the use of the network code scheme produces the effect of saving time resources, and thus this scheme is called a “compressed mode.”

Besides a compressed mode using the network code scheme, a scheme for implementing the compressed mode may be obtained by increasing a modulation order of a modulation scheme. A modulation scheme in which encoded bits of each user equipment is transmitted from each user equipment to a base station is QPSK (Quadrature Phase Shift Keying), and a relay apparatus can transmit encoded bits of each user equipment during a slot according to a QAM (Quadrature Amplitude Modulation) modulation scheme. At this time, encoded bits of each user equipment have a form in which they are independently AM (Amplitude Modulation)-modulated along an I-axis and a Q-axis of a constellation of the QAM modulation scheme. This scheme is called “multiple UE joint modulation.” In a QAM constellation defined in the existing 3GPP LTE standards, mapping is performed by allocating two bits to each of an I-axis and a Q-axis. The QAM constellation has a difference in error correction capability, according to a characteristic of each of signal point sets, between which each of the two bits discriminates. In order to eliminate this difference, a multiple UE joint modulation scheme uses a mapping method different from a constellation used in the 3GPP LTE. The multiple UE joint modulation scheme is known as showing a better FER (Frame Error Rate) than that of a relay system to which a network code is applied.

However, the conventional relay technologies including the relay technology using the network code scheme, a relay technology using the multiple UE joint modulation scheme, etc. have a problem of requiring a separate algorithm for handling a case where there is a difference in the length of a frame between user equipments. Also, the conventional relay technologies have a problem of requiring the development of a new rate matching algorithm for link adaptation between a relay apparatus and a base station. Also, when there is a difference in a modulation scheme between user equipments, the conventional relay technologies have a problem in that complex combination rules must be applied to the combination of signals which are modulated according to different modulation schemes and are then transmitted, respectively. Further, the conventional relay technologies have a problem of combining signals received from three or more user equipments. Besides these problems, the conventional relay technologies also have a problem of causing many changes when the conventional relay technologies are applied to the 3GPP LTE.

### SUMMARY

Therefore, an aspect of the present invention is to solve the above-mentioned problems, and to provide a method and an apparatus for relaying uplink signals, which can be applied to an existing communication system such as 3GPP LTE without many changes even when being applied thereto.

Particularly, an aspect of the present invention is to provide a method and an apparatus for relaying uplink signals, which do not have a problem of combining signals received from three or more user equipments; do not require a separate algorithm for handling a case where there is a difference in the length of a frame between user equipments; do not have to develop a new rate matching algorithm for link adaptation between a relay apparatus and a base station; and do not have to require complex combination rules to combine signals which are modulated according to different modulation schemes and are then transmitted, respectively, when there is a difference in a modulation scheme between user equipments.

Another aspect of the present invention is to provide a method and an apparatus for relaying uplink signals, which can notify a base station whether decoding of a signal received from a user equipment is successful while relaying an uplink signal from the user equipment to the base station.

In order to accomplish the above-mentioned objects, in accordance with an aspect of the present invention, there is provided an apparatus for relaying uplink signals from multiple user equipments to a base station. The apparatus includes: an aggregator for aggregating multiple information blocks from signals received from the multiple user equipments, and generating an aggregate information block; an encoder for encoding the aggregate information block; and a modulator for modulating the encoded aggregate information block.

In accordance with an aspect of the present invention, there is provided a method for relaying uplink signals from multiple user equipments to a base station by a relay apparatus. The method includes: aggregating multiple information blocks from signals received from the multiple user equipments, and generating an aggregate information block; encoding the aggregate information block; and modulating the encoded aggregate information block.

In accordance with another aspect of the present invention, there is provided an apparatus for relaying uplink signals from multiple user equipments to a base station. The apparatus includes: the apparatus for delivering, to the base station, information on success or failure of decoding in a process of decoding each of the signals in the uplink, when the apparatus relays the signals in the uplink transmitted by the multiple user equipments to the base station, wherein the information on the success or failure of the decoding is transmitted through a control information channel in the uplink, or the information on the success or failure of the decoding is included in a signal to be relayed to the base station and the signal including the information on the success or failure of the decoding is transmitted.

In accordance with another aspect of the present invention, there is provided a method for relaying uplink signals from multiple user equipments to a base station by a relay apparatus. The method includes: decoding the signals in the uplink transmitted by the multiple user equipments, and relaying the decoded signals in the uplink to the base station; and delivering information on success or failure of the decoding in decoding of the signals in the uplink, to the base station, wherein, in delivering of the information on the success or failure of the decoding, the information on the success or failure of the decoding is transmitted through a control information channel in the uplink, or the information on the success or failure of the decoding is included in a signal to be relayed to the base station in relaying of the decoded signals in the uplink and the signal including the information on the success or failure of the decoding is transmitted.

As described above, according to an embodiment of the present invention, there is an effect of providing a method and an apparatus for relaying uplink signals, which can be applied to an existing communication system such as 3GPP LTE without many changes even when being applied thereto.

Particularly, according to an embodiment of the present invention, there is an effect of providing a method and an apparatus for relaying uplink signals, which do not have a problem of combining signals received from three or more user equipments; do not require a separate algorithm for handling a case where there is a difference in the length of a frame between user equipments; do not have to develop a new rate matching algorithm for link adaptation between a relay apparatus and a base station; and do not have to require complex combination rules to combine signals which are modulated according to different modulation schemes and are then transmitted, respectively, when there is a difference in a modulation scheme between user equipments.

According to another embodiment of the present invention, there is an effect of providing a method and an apparatus for relaying uplink signals, which can notify a base station whether decoding of a signal received from a user equipment is successful while relaying an uplink signal from the user equipment to the base station.

### BRIEF DESCRIPTION OF THE DRAWINGS

FIG. 1 is a view schematically illustrating a wireless communication system to which an embodiment of the present invention is applied;

FIG. 2 is a block diagram illustrating the configuration of an apparatus for relaying uplink signals according to an embodiment of the present invention;

FIG. 3 is a block diagram illustrating the configuration of an aggregator included in an apparatus for relaying uplink signals according to an embodiment of the present invention;

FIGS. 4A, 4B and 4C are views each illustrating an example of an information block from an uplink signal to be relayed according to an embodiment of the present invention;

FIG. 5 is a view illustrating a detailed configuration of a scheme for aggregating information blocks according to an embodiment of the present invention;

FIG. 6 is a view illustrating the concept of reordering information blocks during aggregation of the information blocks according to an embodiment of the present invention;

FIGS. 7A, 7B and 7C are views illustrating three examples of reordering information blocks according to an embodiment of the present invention;

FIGS. 8A and 8B are views each illustrating an example of an information field for notifying the success or failure of decoding for an information block according to an embodiment of the present invention;

FIG. 9 is a flowchart illustrating a method for relaying uplink signals according to an embodiment of the present invention; and

FIG. 10 is a view explaining the application of a method for relaying uplink signals to 3GPP LTE according to an embodiment of the present invention.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) and the like may be used herein when describing components of the present invention. Each of these terminologies is not used to define an essence, order or sequence of a corresponding component but used merely to distinguish the corresponding component from other component(s). It should be understood that if it is described in the specification that one component is “connected,” “coupled” or “joined” to another component, a third component may be “connected,” “coupled,” and “joined” between the first and second components, although the first component may be directly connected, coupled or joined to the second component.

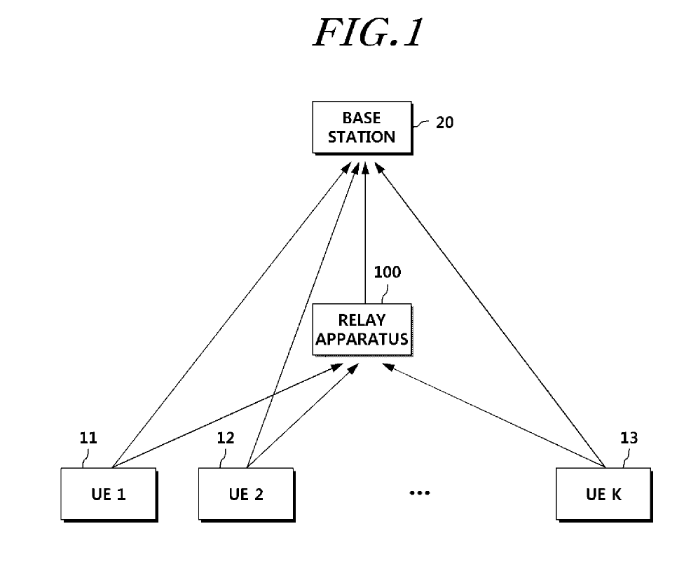

FIG. 1 is a view schematically illustrating a wireless communication system to which an embodiment of the present invention is applied.

Referring to FIG. 1, an apparatus 100 for relaying uplink signals according to an embodiment of the present invention is an apparatus for relaying signals in uplink from multiple user equipments (a user equipment 1 11, a user equipment 2 12, ..., and a user equipment k 13) to a base station 20.

The apparatus 100 for relaying uplink signals receives encoded signals from the multiple user equipments 11, 12, . . . , and 13, decodes the received signals, generates an aggregate information block by using multiple information blocks as the decoded signals matched with the multiple user equipments 11, 12, . . . , and 13, respectively, causes the generated aggregate information block to go through an encoding process, and transmits the encoded aggregate information block to the base station 20. In this case, multiple encoding schemes including a turbo-coding scheme may be used in the apparatus 100.

Hereinafter, the apparatus 100 for relaying uplink signals and a method for relaying signals in uplink (uplink signals) provided by the relay apparatus 100 according to an embodiment of the present invention will be described with reference to the accompanying drawings.

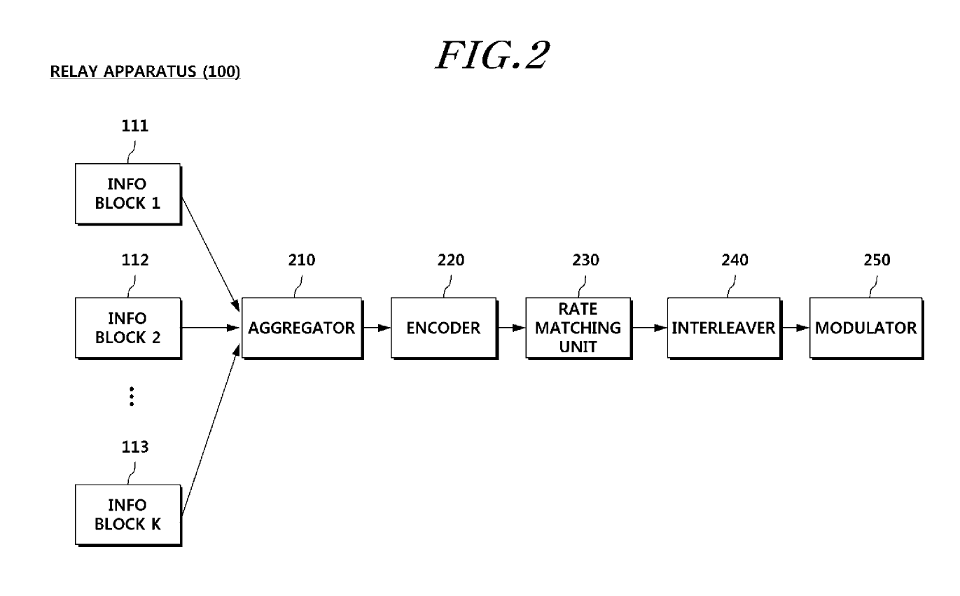

FIG. 2 is a block diagram illustrating the configuration of the apparatus 100 for relaying uplink signals according to an embodiment of the present invention.

Referring to FIG. 2, the apparatus 100 for relaying uplink signals according to an embodiment of the present invention is an apparatus for relaying uplink signals from the multiple user equipments 11, 12, . . . , and 13 to the base station 20. The apparatus 100 includes: an aggregator 210 for aggregating multiple information blocks from signals received from the multiple user equipments 11, 12, . . . , and 13, and generating an aggregate information block; an encoder 220 for encoding the aggregate information block generated by the aggregator 210 according to a predefined encoding scheme; a modulator 250 for modulating the aggregate information block encoded by the encoder 220 according to a predefined modulation scheme; and the like.

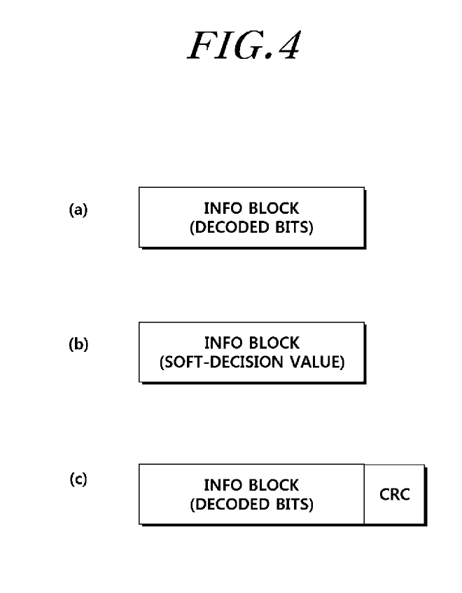

The multiple information blocks as described above may be Transport Blocks (TBs) obtained by decoding the signals which have been received from the multiple user equipments 11, 12, . . . , and 13, respectively. These information blocks have construction forms thereof which may be different according to a result of decoding as exemplified in FIGS. 4A, 4B and 4C. Referring to the examples shown in FIGS. 4A, 4B and 4C, an information block which may be a transport block obtained by decoding a signal transmitted by a particular user equipment, may be constructed from decoded bits as shown in FIG. 4A. Otherwise, the above information block may be constructed from a soft-decision value indicating the success or failure of decoding as shown in FIG. 4B. Otherwise, the above information block may be constructed from decoded bits and an error detection code, such as Cyclic Redundancy Check (CRC), which is added to the decoded bits, as shown in FIG. 4C.

In other words, when decoding is successful, each of multiple information blocks may be a transport block (see FIG. 4A) having a construction form including a decoded bit block. When the decoding fails, each of the multiple information blocks may be a transport block (see FIG. 4B) having a construction form including a soft-decision value (e.g. a soft-decision probability value or a log value of the soft-decision probability value) on a per-bit basis. Otherwise, each of the multiple information blocks may have an error detection code, such as Cyclic Redundancy Check (CRC), which is added to each information block. However, when decoding fails, each information block may not have an error detection code added thereto (see FIG. 4C).

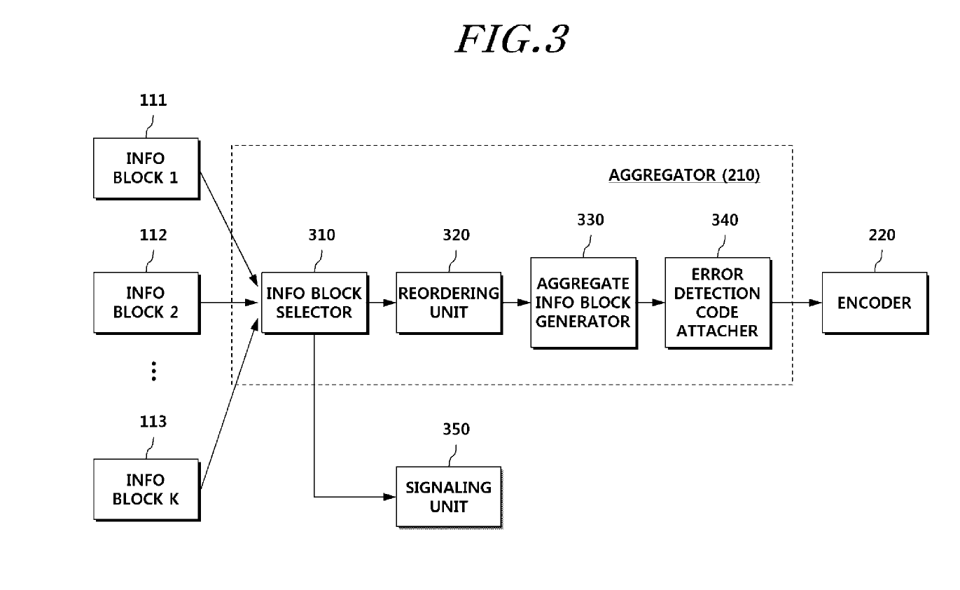

Referring to FIG. 3, the aggregator 210 for aggregating multiple information blocks from signals which have been received from the multiple user equipments 11 and 12, respectively, and generating an aggregate information block, include: an information block selector 310 for selecting, as selection information blocks, all or some of multiple information blocks 111, 112, . . . , and 113, which may be transport blocks obtained by decoding the signals which have been received from the multiple user equipments 11, 12, . . . , and 13, respectively,; a reordering unit 320 for reordering the selection information blocks selected by the information block selector 310 according to predefined reordering rules; an aggregate information block generator 330 for aggregating the reordered selection information blocks and generating an aggregate information block; and the like.

Regardless of the success or failure of decoding for each of the multiple information blocks (an information block 1 111, an information block 2 112, . . . , and an information block k 113), the information block selector 310 may first select all of the multiple information blocks 111, 112, . . . , and 113 as selection information blocks, and may then deliver all of the selected multiple information blocks 111, 112, . . . , and 113 to a reordering unit 320. Otherwise, based on the success or failure of decoding for each of the multiple information blocks 111, 112, . . . , and 113, the information block selector 310 may select some information blocks, for each of which decoding is successful among the multiple information blocks 111, 112, . . . , and 113, as selection information blocks, and may deliver the selected some of the multiple information blocks 111, 112, . . . , and 113 to the reordering unit 320.

As described above, when the information block selector 310 first selects all of the multiple information blocks 111, 112, . . . , and 113 as selection information blocks, and then delivers all of the selected multiple information blocks 111, 112, . . . , and 113 to the reordering unit 320, a selection information block, for which decoding has failed among the selection information blocks, may be delivered in such a manner as to have a soft-decision value (e.g. a soft-decision probability value or a log value of the soft-decision probability value). In contrast, a selection information block, for which decoding has been successful among the selection information blocks, may be delivered in such a manner as to have a hard-decision value (e.g. a binary bit value corresponding to 0 or 1, or a probability value matched with a binary bit value).

Meanwhile, as described above, when the information block selector 310 selects some information blocks, for each of which decoding has been successful among the multiple information blocks 111, 112, . . . , and 113, as selection information blocks, an information block, for which decoding has failed among the multiple information blocks 111, 112, . . . , and 113, may be completely excluded from information blocks transmitted to the base station 20 without specially processing the information block. Otherwise, in some cases, the above information block may be transmitted to the base station 20 in uplink by using a resource (e.g. frequency or time resource) allocated for the transmission of a signal to the base station 20. Otherwise, in some cases, the above information block may be first allocated a separate resource different from the resource allocated for the transmission of a signal, and may then be transmitted to the base station 20 in uplink by using the separate resource.

The apparatus 100 for relaying uplink signals according to an embodiment of the present invention, as shown in FIG. 2, may further include a signaling unit 350 for transmitting signaling information on information blocks, for each of which decoding has been successful among the multiple information blocks 111, 112, . . . , and 113, and information blocks, for each of which decoding has failed therebetween, to the base station 20 as shown in FIG. 3.

The signaling unit 350 may transmit signaling information to the base station 20, only when the information block selector 310 selects some information blocks, for each of which decoding has been successful among the multiple information blocks 111, 112, . . . , and 113, as selection information blocks. The signaling unit 350 may notify the signaling information on information blocks, for each of which decoding has been successful and information blocks, for each of which decoding has failed, not only to the base station 20, but also to the encoder 220.

The signaling unit 350 may transmit the signaling information through a control information channel in uplink. Otherwise, the signaling unit 350 may first include the signaling information in an aggregate information block, which has been obtained by aggregating all or some of the multiple information blocks selected as selection information blocks into one block, in the form of a header, an appendix or the like, and may then transmit the aggregate information block including the signaling information.

The control information channel in uplink as described above, for example, may include a Physical Uplink Control Channel (PUCCH) in 3GPP LTE (hereinafter, referred to as “LTE”), and any channel for control other than the physical uplink control channel may be used as the control information channel in uplink, if any channel for control is only defined.

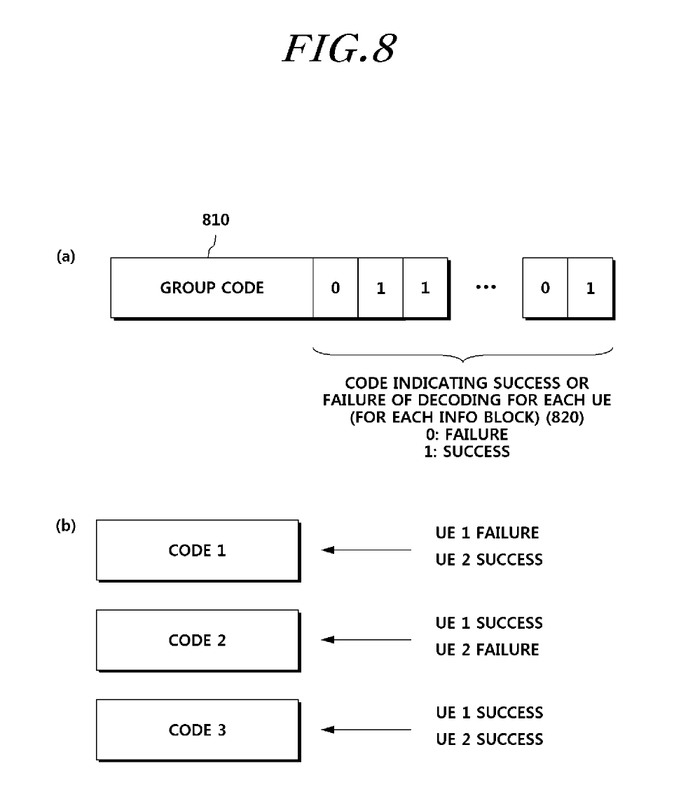

As exemplified in FIG. 8A, the signaling information as described above may include a code 820 indicating the success or failure of decoding for each of the multiple information blocks 111, 112, . . . , and 113 matched with the multiple user equipments 11, 12, . . . , and 13. Namely, the number of codes 820, each indicating the success or failure of decoding, is equal to the number k of the multiple user equipments or the number k of the multiple information blocks. For example, a code indicating the success or failure of decoding for each user equipment or for each information block, is set to 1 in a field corresponding to a relevant information block when decoding has been successful for the relevant information block. Otherwise, the code is set to “0” in the field corresponding to the relevant information block when the decoding has failed for the relevant information block.

Also, the signaling information as described above may further include a group code 810 unique to the multiple user equipments 11, 12, . . . , and 13, as well as the code 820 indicating the success or failure of decoding for each user equipment or for each information block.

Referring to FIG. 8B, differently from the above configuration, signaling may be constructed by assigning different codes to cases each indicating the success or failure of decoding, respectively. The signaling method as shown in FIG. 8B is a scheme for assigning an independent code to each case. As compared with a method for expressing the success or failure of decoding, in a predetermined field as shown in FIG. 8A, the signaling method as shown in FIG. 8B is an option proposed by a concept such that an original code of each user equipment already exists and a code corresponding to a combination of user equipments may be separately assigned. In this case, a code may not be assigned to a case where decoding has failed for each of all of the information blocks, so that it is possible to obtain an advantage in terms of the efficiency of signaling.

Referring to FIG. 3, after the information block selector 310 included in the aggregator 210 selects, as selection information blocks, all or some of the multiple information blocks 111, 112, . . . , and 113, which may be transport blocks obtained by decoding the signals which have been received from the multiple user equipments 11, 12, . . . , and 13, respectively, the reordering unit 320 may reorder the selection information blocks selected by the information block selector 310, according to the predefined reordering rules.

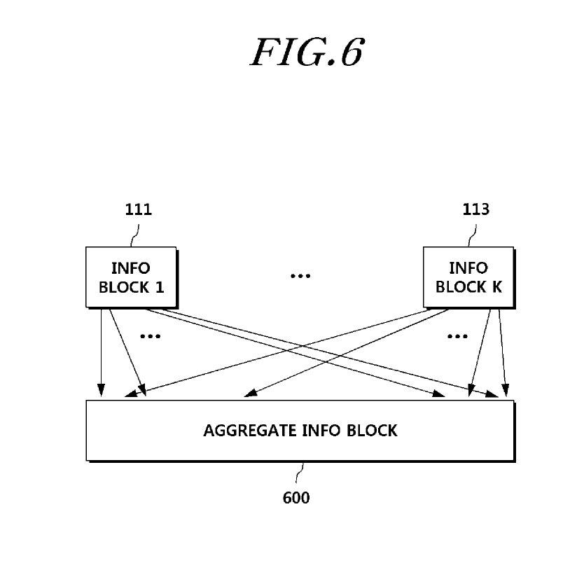

The reordering unit 320 as described above reorders the selection information blocks on a bit-by-bit basis, on a block-by-block basis, or the like according to the predefined reordering rules. The concept of reordering as described above is shown in FIG. 6. As shown in FIG. 6, selection information blocks are aggregated into an aggregate information block 600, on the assumption that the information block 1 111, the information block 2 112, . . . , and the information block k 113 are selected as the selection information blocks.

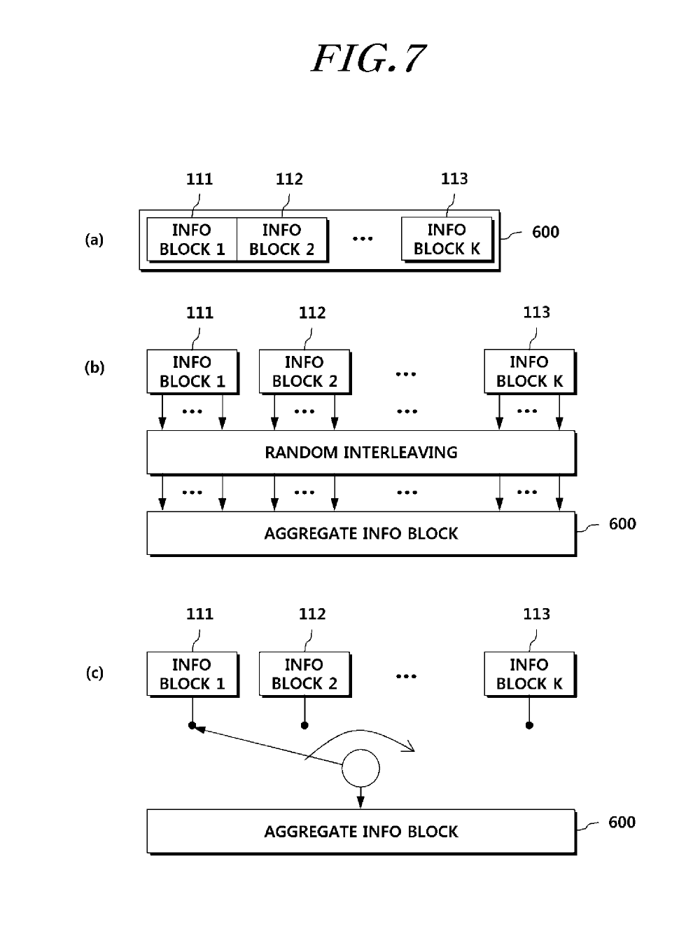

At this time, the reordering rules, for example, may include one or more of selection a rule for connecting information blocks in series, a rule for random- or block-interleaving selection information blocks on a block-by-block basis or on a bit-by-bit basis, a rule for reordering selection information blocks in the form of switching between the selection information blocks, and the like. The three rules exemplified as the reordering rules are shown in FIG. 7. In FIG. 7, it is assumed that the information block 1 111, the information block 2 112, . . . , and the information block k 113 are selection information blocks. As shown in FIG. 7A, the information block 1 111, the information block 2 112, . . . , and the information block k 113 are reordered and are aggregated into an aggregate information block 600, according to a reordering rule for connecting them in series. The compliance with the rule for connecting information blocks in series as described above may cause error correction capability to change according to the location of an information block. Accordingly, it may be more desirable that the information blocks matched with the user equipments are distributed as uniformly as possible over the entire aggregate information block 600.

Therefore, when the number of the information blocks matched with the user equipments is large or when bit lengths of the information blocks matched with the user equipments are different, an algorithm for uniformly distributing the information blocks is required. To this end, as shown in FIG. 7B, the information block 1 111, the information block 2 112, . . . , and the information block k 113 may be random- or block-interleaved, and the multiple information blocks, which may have different lengths, respectively, may be uniformly distributed, so as to enable the generation of the aggregate information block 600. As an example of an interleaver for interleaving as described above, it is possible to apply an interleaver in the form of a sub-block interleaver used in 3GPP LTE R8.

Also, as shown in FIG. 7C, the aggregate information block 600 may be constructed while an information block is selected by using a switch, which is set in such a manner that the frequency of selecting each of the information blocks 111, 112, . . . , and 113 is set to a predetermined value. This scheme for reordering selection information blocks in the form of switching between the selection information blocks, for example, enables the construction of a form of switching between the information blocks once at every predetermined cycle at the same proportion, which does not show optimal performance but corresponds to the simplest implementation form. Such a scheme for switching between information blocks once at every cycle has a simpler algorithm than the case of using a complex switching algorithm. In some cases, there may be no large difference in actual performance between the above scheme and the use of a complex switching algorithm.

The aggregator 210 included in the apparatus 100 for relaying uplink signals according to an embodiment of the present invention as described above with reference to FIG. 3, may further include an error detection code attacher 340, which adds an error detection code (e.g. CRC) to each of the selection information blocks selected by the information block selector 310, or which adds an error detection code (e.g. CRC) to the entire aggregate information block, into which the selection information blocks have been aggregated.

When the error detection code attacher 340 adds an error detection code to each of the selection information blocks which are all or some of the multiple information blocks 111, 112, . . . , and 113, the error detection code attacher 340 may add an error detection code only to each of information blocks, for which decoding has been successful among the selection information blocks. Also, the error detection code attacher 340 may not add an error detection code to each of information blocks, for which decoding has failed among the selection information blocks.

Also, when the error detection code attacher 340 as described above adds an error detection code to the entire aggregate information block obtained by aggregating the selection information blocks which are all or some of the multiple information blocks 111, 112, . . . , and 113, the error detection code attacher 340 may add an error detection code to an entire block of only selection information blocks, for each of which decoding has been successful among the selection information blocks aggregated into the aggregate information block.

Referring to FIG. 2, the apparatus 100 for relaying uplink signals according to an embodiment of the present invention, may further include: a rate matching unit 230 for rate matching the aggregate information block encoded by the encoder 220 before the modulator 250 modulates the aggregate information block encoded by the encoder 220; and an interleaver 240 for interleaving the rate matched aggregate information block.

The apparatus 100 for relaying uplink signals is illustratively shown as first performing rate matching and then performing an interleaving function in FIG. 2. This configuration of the apparatus 100 corresponds to a configuration which may be applied in a Release 99 system. This configuration is only an example. In some cases, as another example, the configuration of the apparatus 100 may have a form of integrating the rate matching function and the interleaving function in a Release 8 system. Namely, the rate matching unit 230 and the interleaver 240 may be integrated, and may become an interleaving/rate matching unit capable of performing the relevant functions. Also, the configuration of the apparatus 100 may have a form of including the interleaver 240 for performing interleaving (or sub-block interleaving) in the rate matching unit 230.

As described above, all or some of the multiple information blocks 111, 112, . . . , and 113 are selected as selection information blocks; the selected selection information blocks are aggregated and an aggregate information block is generated; the generated aggregate information block goes through an encoding process, a rate matching process, and an interleaving process; and the modulator 250 performs modulation according to a predetermined modulation scheme. At this time, the modulator 250, for example, may modulate the aggregate information block according to a Quadrature Amplitude Modulation (QAM) scheme, and may transmit the modulated aggregate information block to the base station 20. At this time, encoded bits of the aggregate information block have a form in which they are independently AM (Amplitude Modulation)-modulated along distinguished axes (an I-axis and a Q-axis) of a constellation of the QAM modulation scheme. The constellation of the QAM modulation scheme which is used herein, has an advantage in that a conventional constellation used in 3GPP LTE can be used for the constellation of the QAM modulation scheme as it is and any constellation of a Gray Mapping scheme can be used therefor.

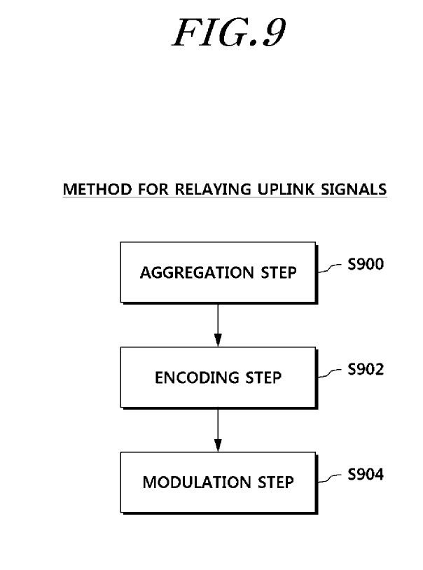

A method for relaying signals in uplink from the multiple user equipments 11, 12, . . . , and 13 to the base station 20, which is performed by the apparatus 100 for relaying uplink signals according to an embodiment of the present invention as described above, will be briefly described with reference to FIG. 9.

FIG. 9 is a flowchart illustrating a method for relaying uplink signals, which is provided by the relay apparatus 100 according to an embodiment of the present invention.

Referring to FIG. 9, a method for relaying uplink signals in uplink from the multiple user equipments 11, 12, . . . , and 13 to the base station 20, by the relay apparatus 100 according to an embodiment of the present invention includes: aggregation step S900 of aggregating multiple information blocks 111, 112, . . . , and 113 from signals received from the multiple user equipments 11, 12, . . . , and 13, and generating an aggregate information block; encoding step S902 of encoding the generated aggregate information block; and modulation step S904 of modulating the encoded aggregate information block.

Although the method for relaying uplink signals is schematically shown as including only aggregation step S900, encoding step S902, and modulation step S904 in a flowchart of FIG. 9, all functions and operations performed by the apparatus 100 for relaying uplink signals as described above with reference to FIG. 1 to FIG. 8, may be added as steps of the method for relaying uplink signals.

Hereinafter, the above method for relaying uplink signals from the multiple user equipments 11, 12, . . . , and 13 to the base station 20, which is applied to 3GPP LTE, will be described. In the following description, with the application of the above method to 3GPP LTE, the user equipment 11, 12, . . . , and 13 are named “UEs”, the base station 20 is named “eNB” (enhanced Node B), an information block is named a “TB” (Transport Block) or “UE TB,” and an aggregate information block obtained by aggregating these information blocks is named an “aggregate TB.”

Although the method for relaying uplink signals from the multiple user equipments 11, 12, . . . , and 13 to the base station 20, disclosed in this specification is applied to 3GPP LTE, the method applied to 3GPP LTE follows, as it is, a method performed by the relay apparatus 100 as shown in FIG. 2. As shown in FIG. 2, multiple UE TBs go through a process of aggregating UE TBs by the aggregator 210, and construct an aggregate TB having an aggregate form. Accordingly, a signal to be transmitted through a channel according to a 3GPP system is generated. In this case, multiple encoding schemes may be used, but it is assumed that a basic encoding scheme is a turbo-coding scheme.

As shown in FIG. 3, in order to aggregate UE TBs, after UE TBs go through a process of selecting a UE TB by the information block selector 310, the selected UE TBs are input to the reordering unit 320 and are reordered on a bit-by-bit basis thereby, and the reordered UE TBs are delivered to the encoder 220 corresponding to the encoding block. Herein, the UE TBs signify the outcome of decoding signals received from UEs by the relay apparatus 100. Accordingly, a UE TB may have a construction form changing according to a result of a decoding process. For example, when decoding is successful for a UE TB, the UE TB may signify a decoded bit block. In contrast, when decoding fails for a UE TB, the UE TB may signify a soft-decision value (e.g. a soft-decision probability value or a log value of the soft-decision probability value) on a per-bit basis, which is output as a result of a turbo decoding process.

A UE TB may be constructed by adding an error detection code (e.g. CRC) thereto, or may be constructed without adding the error detection code (e.g. CRC) thereto. When an error detection code is added to a UE TB, errors are detected for each UE, and a HARQ (Hybrid Automatic Repeat Request) scheme is configured, so that efficiency can be improved. However, when CRC added to each UE TB is considered, basically required control resources become larger. A case where an error detection code is added to an aggregate TB into which UE TBs have been aggregated, instead of adding an error detection code to a UE TB, has advantages and disadvantages contrary to those as described above. When a UE TB is constructed from a soft-decision value (i.e. an error detection code has no meaning to a UE TB, for which decoding has failed), the error detection code is not added to the UE TB.

In consideration of the success or failure of decoding, the selection of a UE TB to be delivered to the reordering unit 320 may be performed by the information block selector 310 in the following several schemes.

According to a first scheme, all UE TBs may be delivered to the reordering unit 320, regardless of the success or failure of decoding. At this time, all UE TBs are selected as selection information blocks.

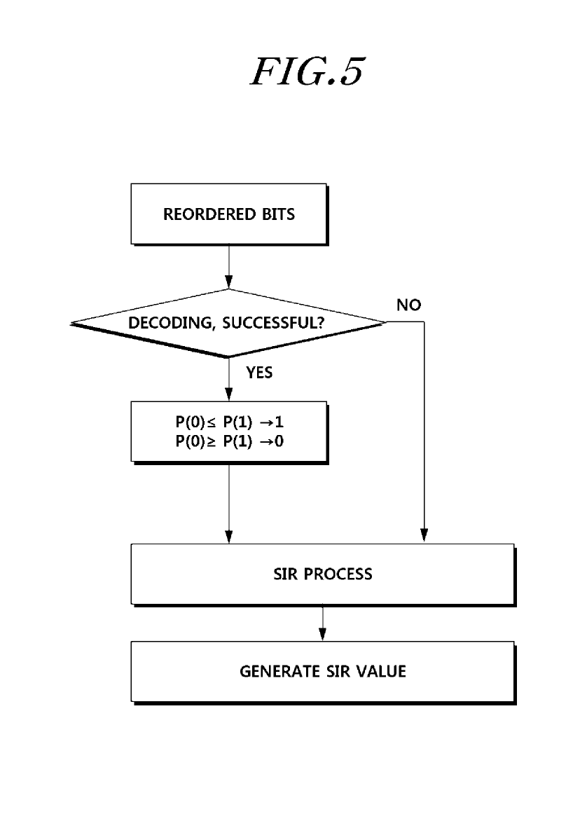

In this case, each of UE TBs, for which decoding has failed, may be output in the form of a soft-decision probability value or a log value of the soft-decision probability value. Turbo-coding of a soft-decision value and the modulation of the turbo-coded soft-decision value may be performed by an algorithm, such as SIR (Soft Information Relaying). When SIR is configured, a hard-decision value of a binary value is assigned to a UE TB, for which decoding has been successful, based on a hard-decided bit value (for example, when expressed as a probability value, a bit decided to be 1 may be assigned a probability value of 1.0, and a bit decided to be “0” may be assigned a probability value of 0.0. When expressed as a log value, a bit decided to be 1 may be assigned a log value of “0,” and a bit decided to be “0” may be assigned a very large value with a minus sign). In contrast, a soft-decision value output from a decoder is assigned to a UE TB, for which decoding has failed. The configuration of SIR as described above is shown in FIG. 5.

When all of the UE TBs are delivered to the reordering unit 320 regardless of the success or failure of decoding, information on which UE TB has a soft-decision value, i.e. for which UE TB decoding has failed (information on the success or failure of decoding) does not have to be delivered to the encoder 220 for performing a turbo coding. Also, there is no need for special signaling notifying an eNB of information on which UE TB has a soft-decision value, i.e. for which UE TB decoding has failed (information on the success or failure of decoding).

Also, when all of the UE TBs are delivered to the reordering unit 320 regardless of the success or failure of decoding, an error detection code may be added to an individual UE TB. However, when an error detection code is not applied to an individual UE TB, an error detection code has only to be constructed for only all blocks, for each of which decoding is successful, and then the constructed error detection code has only to be added to all of the blocks.

Differently from the first scheme as described above, according to a second scheme, only UE TBs, for each of which decoding has been successful, may be delivered to the reordering unit 320. In this case, the information block selector 310 selects only a UE TB, for which decoding is successful among multiple UE TBs, as a selection information block, and delivers the selection information block to the reordering unit 320.

In the case of the second scheme, i.e. when only UE TBs, for each of which decoding has been successful, are delivered to the reordering unit 320, a UE TB for which decoding has failed, is basically and completely excluded from UE TBs transmitted to the eNB, without specially processing the UE TB. However, in some cases, the UE TB, for which decoding has failed, may be transmitted by using a resource allocated for transmission. Otherwise, the UE TB, for which decoding has failed, may first be allocated a resource (frequency or time) other than the resource allocated for transmission, and may then be transmitted by using the allocated resource. When the UE TB, for which decoding has failed, is transmitted, the transmitted UE TB, for which the decoding has failed, is constructed from signals reconstructed by an SIR scheme using a soft-decision value, or may be retransmitted as a signal in the form of a baseband (in the form of I and Q samples) before being decoded.

Also, in the case of the second scheme, i.e. when only UE TBs, for each of which decoding has been successful, are delivered to the reordering unit 320, after a reordering process is performed by the reordering unit 320, in order to perform turbo coding by the encoder 220, information on which UE TB has been selected and which UE TB has not been selected according to whether decoding has been successful (information on the success or failure of decoding or signaling information), must be delivered to the encoder 220 for performing turbo coding.

Also, in the case of the above second scheme, i.e. when only UE TBs, for each of which decoding has been successful, are delivered to the reordering unit 320, an error detection code may be added to an individual UE TB. Otherwise, an error detection code may be constructed for only all UE TBs, for each of which decoding is successful, and then the constructed error detection code may be added to all of the UE TBs.

Further, the above second scheme requires a process for signaling corresponding to the transmission of information on which UE TB has been obtained by successful decoding and which UE TB has been obtained by unsuccessful decoding (information on the success or failure of decoding or signaling information) to the eNB.

As described above, the signaling corresponding to the transmission of information on which UE TB has been obtained by successful decoding to the eNB, is not limited only to the method for relaying uplink signals according to an embodiment of the present invention as described above (i.e. a method for obtaining an aggregate TB by aggregating all or some of multiple UE TBs, encoding the aggregate TB, and transmitting the encoded aggregate TB). Accordingly, the signaling may be commonly applied to a network code scheme, a multiple UE joint modulation (MUJM) scheme, and a compression scheme in a different form. Also, a scheme in which a relay transmits a signal of the UE through the relay in the form of hopping without using a UE link signal, which is not a cooperative scheme for utilizing a link from the UE to the eNB, may also be applied to the signaling for transmitting information on which UE TB has been obtained by successful decoding to the eNB. Namely, even in a typical compression scheme, when the relay apparatus differently processes UE TBs according to the success or failure of decoding for each UE, the signaling for transmitting the success or failure of decoding to the eNB, which corresponds to the above processing, may become an important factor in determining the performance of a communication system, such as signal transmission.

For the signaling as described above, a group code is assigned to each UE group, and as many individual bits (i.e. each individual bit is a code indicating the success or failure of decoding for each user equipment or for each information block) as the number of members (i.e. UEs) of a UE group are assigned to the UEs of the UE group. Accordingly, the success or failure of decoding may be expressed. For example, when the number of UEs is equal to k, as shown in FIGS. 8A and 8B, a method for including a code (the group code 810) representing a UE group, and a field (i.e. the code indicating the success or failure of decoding for each user equipment or for each information block) representing the success or failure of decoding for each of UE TBs matched with a k number of UEs in the UE group, or a method for assigning independent codes, may be used to represent the success or failure of decoding.

As described above, a scheme for notifying the success or failure of decoding for each UE TB, may be included in a control information channel (e.g. a PUCCH in 3GPP LTE) in uplink to the eNB. Another scheme in which an aggregate TB includes information representing the success or failure of decoding in the form of a header or an appendix, may be used to notify the success or failure of decoding.

Also, as applied in 3GPP LTE, information on the success or failure of decoding may be delivered in the form of masking or setting of an initial value of CRC corresponding to one of error detection codes. In this case, an error detection code may be attached to each UE TB, or an error detection code may be added to the entire aggregate TB in order to transmit information. The configuration shown in FIGS. 8A and 8B may be implemented by using a Cell Radio Network Temporary Identifier (C-RNTI) applied in 3GPP LTE.

When the number of UEs in a UE group is equal to 1, a field representing the success or failure of decoding itself (0 or 1 may represent the success or failure) is not required, and a group code corresponding to a code indicating a UE group may represent a code identifying a UE. In the case of the second scheme where only UE TBs, for each of which decoding has been successful, are delivered to the reordering unit 320, the assignment, itself, of a code identifying a UE represents the success or failure of decoding. It can be noted that a case where a code identifying a UE is assigned as described above, corresponds to not a compressed mode but a cooperative relay scheme in a basic form. Also, in this case, it can be noted that representation in the form of a UE group form becomes a superset of a scheme for representing the success or failure of decoding in the form of a UE. Accordingly, a scheme for representing the success or failure of decoding by using a UE group may also be used as a scheme for delivering the success or failure of decoding according to the cooperative relay scheme in a basic form.

A reordering process performs an operation of changing the order of bits of each UE TB bit on a bit-by-bit basis, as shown in FIG. 6. The operation of changing the order of bits may have a form of multiplexing, and may be constructed so as to have a random order or so as to have a form of block interleaving. The simplest scheme among these reordering schemes is to connect UE TBs in order in a serial configuration, as shown in FIG. 7A. When UE TBs are connected in a serial configuration as described above, error correction capability may significantly change according to the location of a UE TB. Accordingly, it may be more desirable that the UE TB s are distributed as uniformly as possible in the entire aggregate TB. Therefore, when the number of the UE TBs is large or when bit lengths of the UE TBs are different, an algorithm for uniformly distributing the UE TBs is required. In this case, as shown in FIG. 7B, a block- or random-interleaver may be used to reconstruct the order of multiple UE TBs having different lengths in such a manner that the multiple UE TBs are uniformly distributed. For example, the order may be reconstructed by using a sub-block interleaver in 3GPP LTE (R8). Also, as shown in FIG. 7C, when UE TBs are reordered according to a scheme for selecting a UE TB in the form of switching between the UE TBs, if the frequency of selecting a UE TB by each switch is determined according to the bit length of each UE TB, an entire block including the multiple uniformly-distributed UE TBs may be constructed. When UE TBs are reordered according to the scheme for selecting a UE TB in the form of switching between the UE TBs, as shown in FIG. 7C, for example, it is possible to construct a form of switching between the information blocks once at every predetermined cycle at the same proportion, which does not show optimal performance but corresponds to the simplest implementation form.

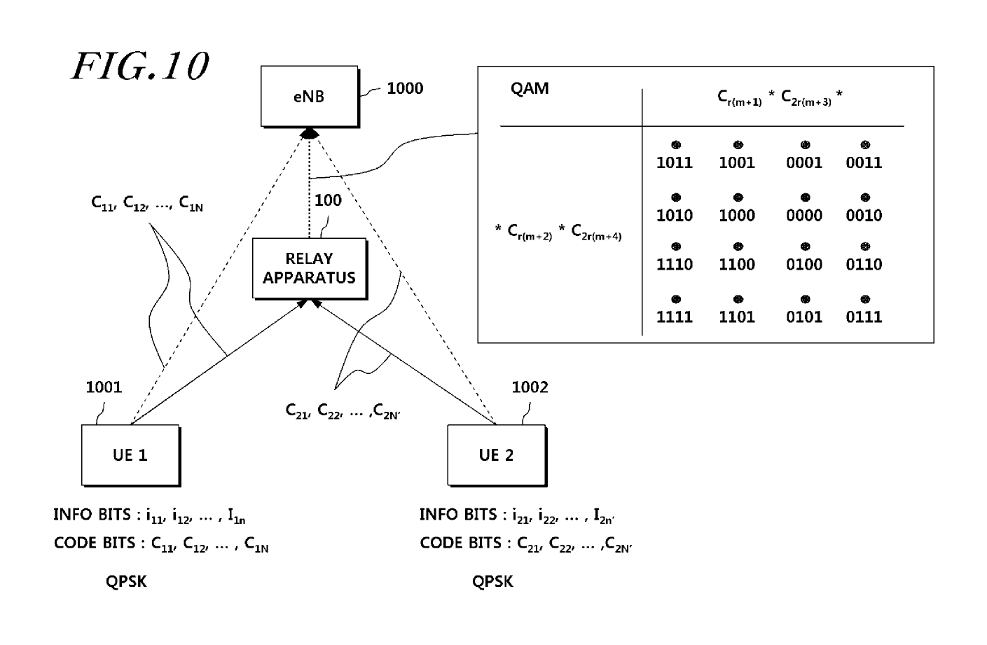

FIG. 10 is a view illustrating an embodiment of aggregating UE TBs according to an embodiment of the present invention. Referring to FIG. 10, for convenience of description, two UEs including a UE 1 1001 and a UE 2 1002 are connected to an eNB 1000 and the relay apparatus 100. A modulation scheme from the UE 1 1001 and the UE 2 1002 to the relay apparatus 100 or the eNB 1000, is a QPSK (Quadrature Phase Shift Keying) modulation scheme. Also, a modulation scheme from the relay apparatus 100 to the eNB 1000 is a QAM (Quadrature Amplitude Modulation) modulation scheme. When this case is compared with the conventional multiple UE joint modulation (MUJM) scheme, the length of an entire block (an aggregate TB) which is input for turbo coding, becomes twice as long as that in the conventional multiple UE joint modulation scheme, and there occurs relative interleaving gain.

When the apparatus 100 for relaying signals in uplink from the multiple user equipments 11, 12, . . . , and 13 to the base station 20 according to another embodiment of the present invention, relays signals in uplink transmitted by the multiple user equipments 11, 12, . . . , and 13 to the base station 20, the apparatus 100 may transmit information on the success or failure of decoding in a process of decoding each of the signals in uplink, to the base station 20. In this case, the relay apparatus 100 may transmit the information on the success or failure of decoding (which is matched with the signaling information as described above) to the base station 20 through a control information channel in uplink. Otherwise, the relay apparatus 100 may first include the information on the success or failure of decoding in a signal to be relayed to the base station 20, in the form of a header or an appendix, and may then transmit the signal including the information on the success or failure of decoding to the base station 20.

The control information channel in uplink as described above may include, for example, a Physical Uplink Control Channel (PUCCH).

Also, a signal to be relayed to the base station 20, which may include the information on the success or failure of decoding, may be an information block generated from signals transmitted by the multiple user equipments 11, 12, . . . , and 13 according to a network code scheme, a multiple UE joint modulation (MUJM) scheme, or the like. Otherwise, the signal to be relayed to the base station 20 may be an aggregate information block generated by aggregating signals transmitted by the multiple user equipments 11, 12, . . . , and 13 according to the scheme as described above with reference to FIG. 1 to FIG. 9. In this case, the aggregate information block may be obtained by aggregating all individual information blocks, which have been obtained by decoding the signals transmitted by the multiple user equipments 11, 12, . . . , and 13, respectively. Otherwise, the aggregate information block may be obtained by aggregating only information blocks, for each of which decoding has been successful among all of the individual information blocks.

The information on the success or failure of decoding as described above, may include, as fields, the code 820 indicating the success or failure of decoding for each of the multiple user equipments 11, 12, . . . , and 13, and the group code 810 for a group of the multiple user equipments 11, 12, . . . , and 13, as shown in FIG. 8. Otherwise, the information on the success or failure of decoding may be constructed by assigning independent codes.

In a method for relaying signals in uplink from the multiple user equipments 11, 12, . . . , and 13 to the base station 20 by the apparatus 100 for relaying uplink signals according to another embodiment of the present invention, the method may include: a first step of first decoding the signals in uplink transmitted by multiple user equipments 11, 12, . . . , and 13, and then relaying the decoded signals in uplink to the base station 20; and a second step of transmitting information on the success or failure of the decoding in process of the decoding to the base station 20. In the second step as described above, the information on the success or failure of decoding may be transmitted through a control information channel in uplink. Otherwise, the information on the success or failure of decoding may first be included in a signal to be relayed to the base station in the first step, and then the signal including the information on the success or failure of decoding may be transmitted.

As described above, an embodiment of the present invention can provide a method and an apparatus for relaying uplink signals, which can be applied to an existing communication system such as 3GPP LTE without many changes even when being applied thereto. Particularly, an embodiment of the present invention can provide a method and an apparatus for relaying uplink signals, which do not have a problem of combining signals received from three or more user equipments; do not require a separate algorithm for handling a case where there is a difference in the length of a frame between user equipments; do not have to develop a new rate matching algorithm for link adaptation between a relay apparatus and a base station; and do not have to require complex combination rules to combine signals which are modulated according to different modulation schemes and are then transmitted, respectively, when there is a difference in a modulation scheme between user equipments.

Also, another embodiment of the present invention can provide a method and an apparatus for relaying uplink signals, which can notify a base station whether decoding of a signal received from a user equipment is successful while relaying an uplink signal from the user equipment to the base station.

Although it has been described in the above that all the components of an embodiment of the present invention are coupled as a single unit or coupled to be operated as a single unit, the present invention is not necessarily limited to such an embodiment. Namely, within the purpose of the present invention, one or more components among the components may be selectively coupled to be operated as one or more units. Also, although each of the components may be implemented as an independent hardware, some or all of the components may be selectively combined with each other, so that they may be implemented as a computer program having one or more program modules for performing some or all of the functions combined in one or more hardwares. Codes and code segments forming the computer program can be easily conceived by an ordinarily skilled person in the technical field of the present invention. Such a computer program may implement the embodiments of the present invention by being stored in a computer-readable medium, and being read and executed by the computer. Storage mediums for storing the computer program may include a magnetic recording medium, an optical recording medium, a carrier wave medium, etc.

In addition, since terms, such as “including,” “comprising,” and “having” mean that one or more corresponding components may exist unless they are specifically described to the contrary, it shall be construed that one or more other components can be further included. All of the terminologies including one or more technical or scientific terminologies have the same meanings that those having ordinary knowledge in the technical field of the present invention understand ordinarily unless they are defined otherwise. A term ordinarily used like that defined by a dictionary shall be construed that it has a meaning equal to that in the context of a related description, and shall not be construed in an ideal or excessively formal meaning unless it is clearly defined in the present specification.

Although exemplary embodiments of the present invention have been described for illustrative purposes, those having ordinary knowledge in the technical field of the present invention will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the technical idea of the present invention is not limited by the embodiments. The protection scope of the present invention should be construed based on the accompanying claims, and it should be construed that all of the technical ideas included within the scope equivalent to the claims are included within the right scope of the present invention.

1. An apparatus for relaying uplink signals from multiple user equipments to a base station, the apparatus comprising:
an aggregator for aggregating multiple information blocks from signals received from the multiple user equipments, and generating an aggregate information block;
an encoder for encoding the aggregate information block; and
a modulator for modulating the encoded aggregate information block.

2. The apparatus as claimed in claim 1, wherein the multiple information blocks correspond to transport blocks (TBs) obtained by decoding the signals received from the multiple user equipments, respectively, and each of the multiple information blocks has a construction form changing according to a result of decoding therefor.

3. The apparatus as claimed in claim 2, wherein each of the multiple information blocks corresponds to the transport block having a construction form including a decoded bit block when decoding for each of the multiple information blocks is successful; and
wherein each of the multiple information blocks corresponds to the transport block having a construction form including a soft-decision value on a per-bit basis when the decoding therefor fails.

4. The apparatus as claimed in claim 3, wherein each of the multiple information blocks has an error detection code added thereto, but does not have the error detection code added thereto when the decoding therefor fails.

5. The apparatus as claimed in claim 1, wherein the aggregator comprises:
an information block selector for selecting at least some of the multiple information blocks as selection information blocks;
a reordering unit for reordering the selection information blocks according to predefined reordering rules; and
an aggregate information block generator for generating the aggregate information block by aggregating the reordered selection information blocks.

6. The apparatus as claimed in claim 5, wherein the information block selector selects all of the multiple information blocks as the selection information blocks and delivers all of the multiple selected information blocks to the reordering unit, regardless of success or failure of decoding for each of the multiple information blocks, or
the information block selector selects some information blocks, for each of which the decoding has been successful among the multiple information blocks, as the selection information blocks and delivers the some selected information blocks to the reordering unit, based on the success or failure of the decoding for each of the multiple information blocks.

7. The apparatus as claimed in claim 6, wherein, when the information block selector selects all of the multiple information blocks as the selection information blocks and delivers all of the multiple selected information blocks to the reordering unit, each of selection information blocks, for which the decoding has failed among the selection information blocks, is delivered in such a manner as to include a soft-decision value, and each of selection information blocks, for which the decoding has been successful among the selection information blocks, is delivered in such a manner as to include a hard-decision value.

8. The apparatus as claimed in claim 6, wherein the relay apparatus further comprises a signaling unit for transmitting, to the base station, signaling information on information blocks, for each of which the decoding has been successful among the multiple information blocks, and information blocks, for each of which the decoding has failed therebetween.

9. The apparatus as claimed in claim 8, wherein the signaling unit transmits the signaling information to the base station only when the information block selector selects some information blocks, for each of which the decoding has been successful among the multiple information blocks, as the selection information blocks.

10. The apparatus as claimed in claim 8, wherein the signaling unit transmits the signaling information by using a control information channel in the uplink, or includes the signaling information in the aggregate information block and transmits the aggregate information block including the signaling information.

11. The apparatus as claimed in claim 10, wherein the control information channel comprises a physical uplink control channel (PUCCH).

12. The apparatus as claimed in claim 8, wherein the signaling information comprises a code for indicating the success or failure of decoding for each of the multiple information blocks matched with the multiple user equipments, respectively.

13. The apparatus as claimed in claim 12, wherein the signaling information further comprises a group code for the multiple user equipments.

14. The apparatus as claimed in claim 6, wherein the aggregator further comprises an error detection code attacher for adding an error detection code to each of the selection information blocks, or adding an error detection code to an entire aggregate information block, into which the selection information blocks have been aggregated.

15. The apparatus as claimed in claim 14, wherein the error detection code attacher adds the error detection code only to each of information blocks, for which the decoding has been successful among the selection information blocks, when the error detection code attacher adds the error detection code to each of the selection information blocks; and
wherein the error detection code attacher adds the error detection code to an entire block of only selection information blocks, for each of which the decoding has been successful among the selection information blocks aggregated into the aggregate information block, when the error detection code attacher adds the error detection code to the entire aggregate information block, into which the selection information blocks have been aggregated.

16. The apparatus as claimed in claim 1, further comprising:
before the modulation of the encoded aggregate information block, a rate matching unit for rate matching the encoded aggregate information block; and
an interleaver for interleaving the rate matched aggregate information block.

17. The apparatus as claimed in claim 1, wherein the modulator modulates the aggregate information block according to a quadrature amplitude modulation (QAM) scheme.

18. A method for relaying uplink signals from multiple user equipments to a base station by a relay apparatus, the method comprising:
aggregating multiple information blocks from signals received from the multiple user equipments, and generating an aggregate information block;
encoding the aggregate information block; and
modulating the encoded aggregate information block.

19. An apparatus for relaying uplink signals from multiple user equipments to a base station, the apparatus comprising:
the apparatus for delivering, to the base station, information on success or failure of decoding in a process of decoding each of the signals in the uplink, when the apparatus relays the signals in the uplink transmitted by the multiple user equipments to the base station,
wherein the information on the success or failure of the decoding is transmitted through a control information channel in the uplink, or the information on the success or failure of the decoding is included in a signal to be relayed to the base station and the signal including the information on the success or failure of the decoding is transmitted.

20. The apparatus as claimed in claim 19, wherein the control information channel in the uplink comprises a physical uplink control channel (PUCCH).

21. The apparatus as claimed in claim 19, wherein the signal to be relayed to the base station corresponds to an information block generated from the signals transmitted by the multiple user equipments according to a network code scheme or a multiple User Equipment (UE) joint modulation (MUJM) scheme, or
the signal to be relayed to the base station corresponds to an aggregate information block generated by aggregating the signals transmitted by the multiple user equipments.

22. The apparatus as claimed in claim 20, wherein the aggregate information block is obtained by aggregating only information blocks, for each of which decoding has been successful among individual information blocks obtained by decoding the signals transmitted by the multiple user equipments, respectively.

23. The apparatus as claimed in claim 19, wherein the information on the success or failure of the decoding comprises:
a code indicating success or failure of decoding for each of the multiple user equipments; and
a group code for the multiple user equipments.

24. A method for relaying uplink signals from multiple user equipments to a base station by a relay apparatus, the method comprising:
decoding the signals in the uplink transmitted by the multiple user equipments, and relaying the decoded signals in the uplink to the base station; and
delivering information on success or failure of the decoding in decoding of the signals in the uplink, to the base station,
wherein, in delivering of the information on the success or failure of the decoding, the information on the success or failure of the decoding is transmitted through a control information channel in the uplink, or the information on the success or failure of the decoding is included in a signal to be relayed to the base station in relaying of the decoded signals in the uplink and the signal including the information on the success or failure of the decoding is transmitted.
